(19) United States
(12) Patent Application Publication
(10) Pub. No.: US 2005/0021526 A1
(43) Pub. Date: Jan. 27, 2005

(54) Method for ensuring the availability of a service proposed by a service provider

(75) Inventors: Philippe Bazot, Vence (FR); Francois-Xavier Drouet, Nice (FR)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/615,504

(22) Filed: Jul. 8, 2003

(30) Foreign Application Priority Data
Jul. 11, 2002 (EP) 02368079.6

(51) Int. Cl. G06F 17/00

(52) U.S. Cl. 707/100

(57) ABSTRACT

Method for ensuring the availability of a service proposed by a service provider in a data transmission system. The method includes looking in a context table for a Uniform Resource Locator (URL) defined in a service request in order to determine the server able to provide the requested service, appending a service availability request to the request before sending the request to the server, appending a service availability token to the reply provided by the server before sending the reply to the proxy, removing the service availability token from the reply upon reception thereof by the proxy, and updating the context table in the proxy before sending the reply to the user workstation by using information contained in the service availability token.

### TECHNICAL FIELD

The present invention relates to the accessibility of the services furnished by service providers to users connected to the Internet network and relates in particular to a method for ensuring the availability of a service proposed by a service provider or the like over the Internet network.

### BACKGROUND OF THE INVENTION

The Service Provider market moves up the value chain from pure connectivity services to deliver value-added and revenue generating services. The business model of a Service Provider was initially driven by minutes of use and is being more and more replaced by data traffic, generated by users that access to external services, typically not maintained by the Service Provider itself but accessed through the Service Provider platform. The Service Provider plays a key role since it is the intermediary between the Subscriber and the external services. Its privileged position allows him to not only provide just “simple” access but added value services such as security, single sign on, billing, location, etc. at the condition it could guarantee a level of service.

In the World Wide Web (WWW) context where the device being used to access the external Web Services is typically a Web browser, this simple problem often requires a complex answer.

When the Web first arrived, it seemed like a glorious new way to communicate. Everything has been designed with the main objective of being open, simple, and easy to implement. HyperText Markup Language, the language used to build Web pages, is simple, clean and easy to learn. Hyperlinks give developers a new way to connect and organize information cleanly. Documents can cross international boundaries with ease. But one of the greatest losses is state maintenance. A Web server does not care whose computer it is on, what country that computer is in, how that computer reached this page, who is currently typing and clicking on that computer, or even how long the page was loaded. Every connection to a server is a separate event, unconnected to any previous events. A Web server does not have the capability to control and adapt the traffic it receives.

In order to control the traffic generated by the clients, a component is put between the clients and the server. In the WWW context, this component named a proxy is located in the service provider platform, and the client web browser is enforced to go through the web proxy by configuration rules.

There are several ways to deploy a proxy. One of them is to deploy the proxy as a “reverse proxy” to add more security to their platform and to protect in an efficient way their back-end Web services. Very often, these services need to maintain a session context in order to be able to associate a web session to an user context.

When a proxy server is configured as a reverse proxy server, it appears to the client to be the destination content server. To the content server, the reverse proxy server acts as the originator of client requests. If a client wants to access a file, for example main.html, he points its browser to the reverse proxy, www.DomainA.com believing this to be the Internet address of the content server. The reverse proxy server will accept the client request for main.html, retrieve the requested page from the content server residing on w3.DomainB.com, and return it to the client.

A reverse proxy server hides the content servers from the public Internet because only the reverse proxy server can directly communicate with the content server from outside a firewall. Moreover, since Web site content may span multiple Web servers for performance and content distribution, the reverse proxy mode may be used to the internal or back-end Web servers.

The requests transmitted by the clients are generally using the HyperText Transfer Protocol (HTTP). With such a protocol, the request (and also the response) includes three parts: the request line identifying the resource the client is requesting, the HTTP header used to transfer information between the client and the server, and the message content. In a system using the HTTP protocol, the HTTP proxy can be configured to protect access to the content server and its resources. It can be configured to enable basic authentication to all users that try to access the proxy function by prompting for a user name and password which can be checked towards an user registry.

But, even though the use of a reverse proxy between the users and the content servers enables the security of the communication to be guaranteed, it is not possible to control the availability of a service provider in real time before sending any new request. So, when the proxy receives requests, it is not able to reject requests even if the server is already overloaded by previous requests thus leading to performance degradation or server failure.

### SUMMARY OF THE INVENTION

Accordingly, the one object of the invention is to achieve a method taking advantage of the existing HTTP protocol implemented in a proxy for ensuring the availability of a service proposed by a service provider or the like.

The invention relates therefore to a method for ensuring the availability of a service proposed by a service provider or the like in a data transmission system including at least one user workstation connected to the Internet network, a plurality of content servers able to furnish services provided by service providers in response to service requests from the user workstation, and a proxy server interconnected between the Internet network and the content servers for receiving the service requests from the user workstation and transmitting each one to the content server able to provide the requested service. The method comprises the following steps when the proxy server receives a service request,
looking in a context table for an entry corresponding to a Uniform Resource Locator (URL) defined in the service request in order to determine the content server able to provide the requested service,
appending a service availability request to the service request before sending the service request from the proxy server to the determined content server,
appending a service availability token to the reply provided by the determined content server before sending the reply from the determined content server to the proxy server,
removing the service availability token from the reply upon reception thereof by the proxy server, and
updating the context table in the proxy server before sending the reply to the user workstation by using information contained in the service availability token.

### BRIEF DESCRIPTION OF THE DRAWINGS

The above and other objects, features and advantages of the invention will be better understood by reading the following more particular description of the invention in conjunction with the accompanying drawings wherein:

FIG. 1 is a block diagram representing a system wherein the method according to the invention is implemented.

FIG. 2 is a flow chart representing the steps of the method which are achieved in the proxy server to transmit a service availability request.

FIG. 3 is a flow chart representing the steps of the method which are achieved in the proxy server when an entry has to be refreshed.

FIG. 4 is a flow chart representing the steps of the method which are achieved in the proxy server upon receiving a service availability token.

### DETAILED DESCRIPTION OF THE INVENTION

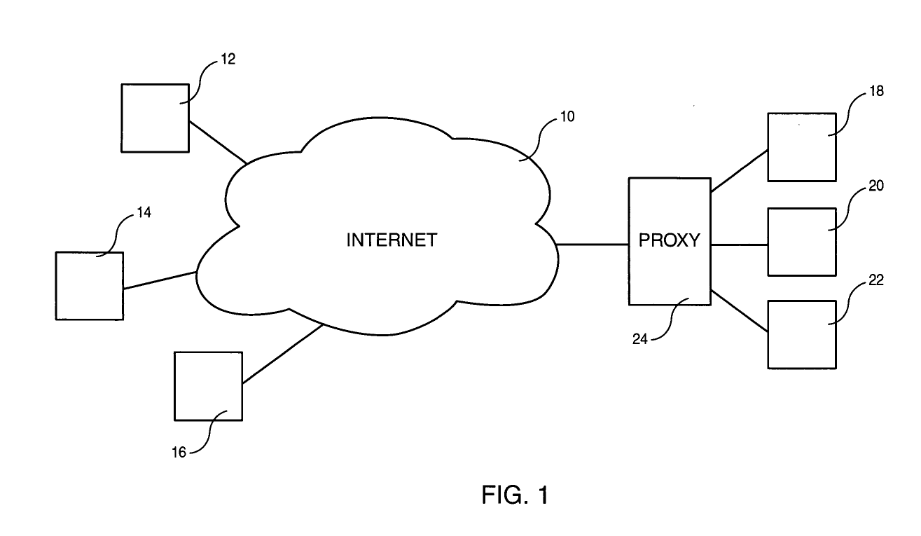

A system wherein the method according to the invention is implemented is illustrated in FIG. 1. Such a system includes the Internet network 10, a plurality of user workstations 12, 14, 16 connected to the Internet network and a plurality of content servers 18, 20 and 22 connected to the Internet network by means of a proxy server 24. Such a proxy server may be a forward proxy or a reverse proxy, although is desirable to use a reverse proxy in order to add more security to the system and to protect in an efficient way the back-end web services. As part of the proxy functionalities, the HTTP proxy can be configured to protect access to the proxy server and its resources. It can be configured to enable basic authentication to the user by prompting for a user name and a password.

For the implementation of the method according to the invention, one feature is to use a context table which contains at least the following information:

| | | | | | | | |
|---|---|---|---|---|---|---|---|
| Server Name | Server | URL | Availability | Last | Request | Number | Last sent |
| | IP address | | | received | sent | of retries | |

The server name is the hostname of the back-end server as contained in the URL.
The IP address is in IP V4 or IP V6 format.

URL: One of the URLs associated with the server name.
Availability: a percentage or NA for not “available”.
Last received: date and time of the last received token from the server.
Request sent: flag indicating whether an availability request has already been sent. It is reset every time a response is received.
Number of retries: number of times a service availability request has been sent.
Last sent: date and time of the last sent availability request.

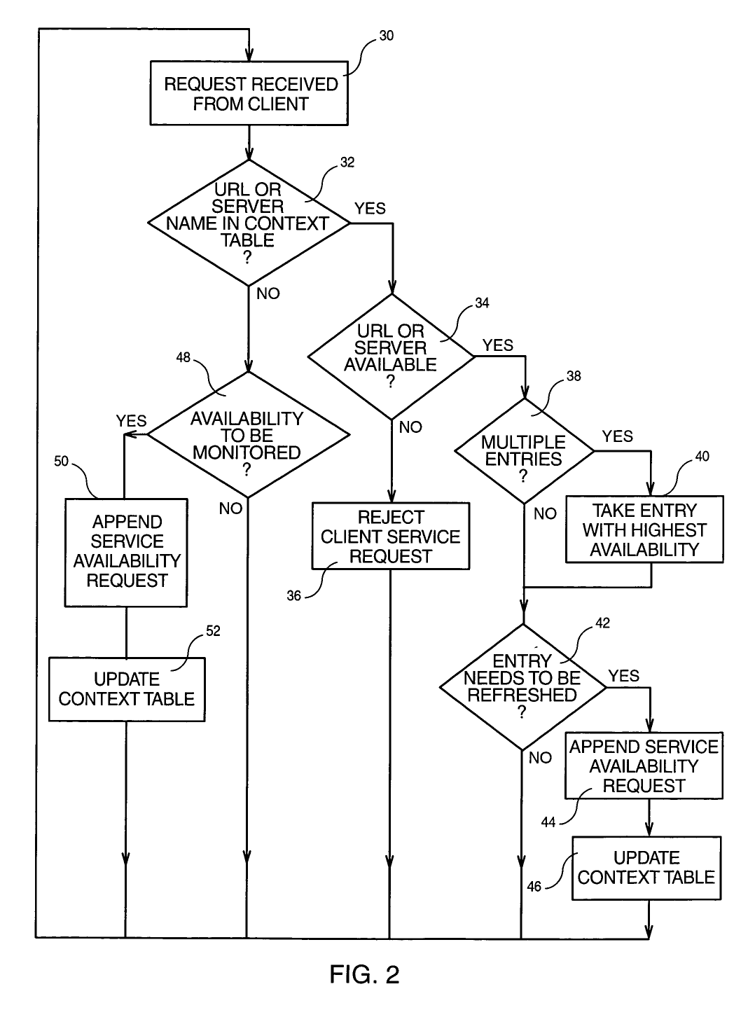

The part of the method according to the invention which is performed in the proxy is represented by the flow chart illustrated in FIG. 2. First, a request is received from a client (step 30). It is checked whether the URL or the server name contained in the request is in the context table (step 32). It must be noted that several entries in the context table are possible with the same server since a single hostname can be associated with several URLs. Note also that, before looking for the context table, the proxy may have to authenticate and/or authorize the user to access the service by using a user profile information.

Then, it is checked in the context table whether the server or the URL is available by looking at the column “Availability” of the table (step 34). If not, the client request is rejected (step 36). If the server or the URL is available, it is checked whether there are multiple entries when a service can be accessed with several servers (step 38). If so, the entry with the highest availability is selected (step 40). In both cases, it is checked whether the entry which has been selected needs to be refreshed (step 42). This need is determined according to criteria which are read in the context table as defined below. If it is the case, a service availability request is appended to the client request which is transmitted from the proxy to the content server (step 44). Then, the context table is updated by modifying the “Number of retries” and the “Last sent” parameter (step 46). If the entry needs not to be refreshed, or after the updating of the context table in case the entry has been refreshed, or when the client request is rejected because the server is not available, the process is looped back to the beginning that is waiting for a new request from a client (step 30).

When the URL or the server name is not found in the context table, it is checked whether the availability of the server or the URL has to be monitored (step 48). If it is the case, a service availability request is appended to the client request which is transmitted from the proxy to the content server (step 50). In such a case, the context table has to be updated since a new entry must be created in the table (step 52). After updating the context table or if it is not required to monitor the availability of the server, the process is looped back to the beginning that is waiting for a new request received from a client (step 30).

It must be noted that the service availability request is sent into the HTTP header of the HTTP requests sent by the proxy to the servers. It follows the form of a regular HTTP headers as described in the specification RFC 2616.

The proposed format of the header is as follows
Service-availability: version_number (Version_number being the version number of the service availability protocol supported by the proxy (1.0 by default)).

An example of a HTTP request containing this header would be
GET http://url HTTP1.0
User-agent: Mozilla/4.0
Accept: text/html, image/gif
Forwarded: by http://proxy.company.com:8080
Service-availability: 1.0

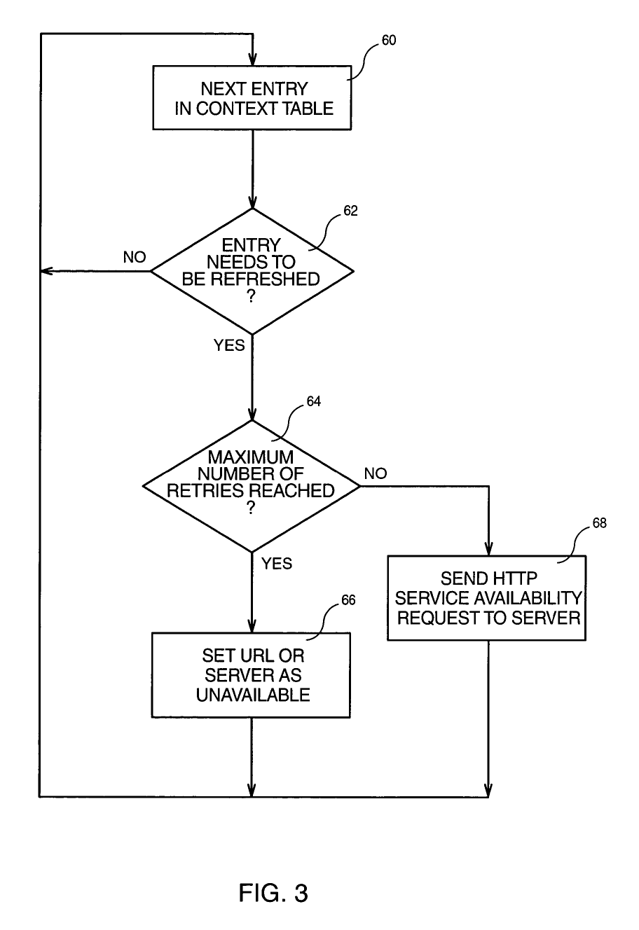

The part of the method relating to the steps to refresh an entry of the context table is illustrated in FIG. 3. First, a new entry is pointed to in the context table (step 60). Then, it is checked whether this entry has to be refreshed as determined by criteria given in the context table as explained below (step 62). If so, it is checked in the context table whether the maximum number of retries has been reached (step 64). If it is the case, this means that the URL or the server is no longer available and the URL or server is set as unavailable in the context table (step 66). If the maximum number of retries has not been reached, a new HTTP service availability request is sent to the server (step 68). In both cases and when the entry does not need to be refreshed, the process is looped back to the beginning by pointing to a next entry in the context table (step 60).

For the determination whether an entry has to be refreshed, the proxy uses the parameters of the context table such as “Request sent,” “Number of retries,” “Last received,” “Last send” together with a configuration file containing the following variables:
SARetry: Service availability retry timer
SARefresh: Service availability refresh timer
MxRet: Maximum number of retries

The test ENTRY NEEDS TO BE REFRESHED can be performed by taking into account the time spent since the last received token (parameter “Last received”), the time spent since the last sent request (parameter “Last sent”), the fact that a request has already been sent without receiving a token and the number of retries already performed. It is achieved by the following program:

```
IF ( (current_time - last_received) > SARefresh ) THEN
  IF (request_sent = Yes) THEN
    IF ( ( current_time - last_sent) > SARetry) THEN
      IF ( Number of retries < MxRet ) THEN
        Append Service Availability Request
        Request sent = Yes
        Number of retries = 1
        Last_sent = current_time
      ELSE
        Update Context Table with Availability = Not
        Available /*max number of retries is reached
    ELSE
      /* Do nothing
  ELSE
    Append Service Availability Request
    Request sent = Yes
    Number of retries = 1
    Last_sent = current_time
ELSE
  Do nothing
```

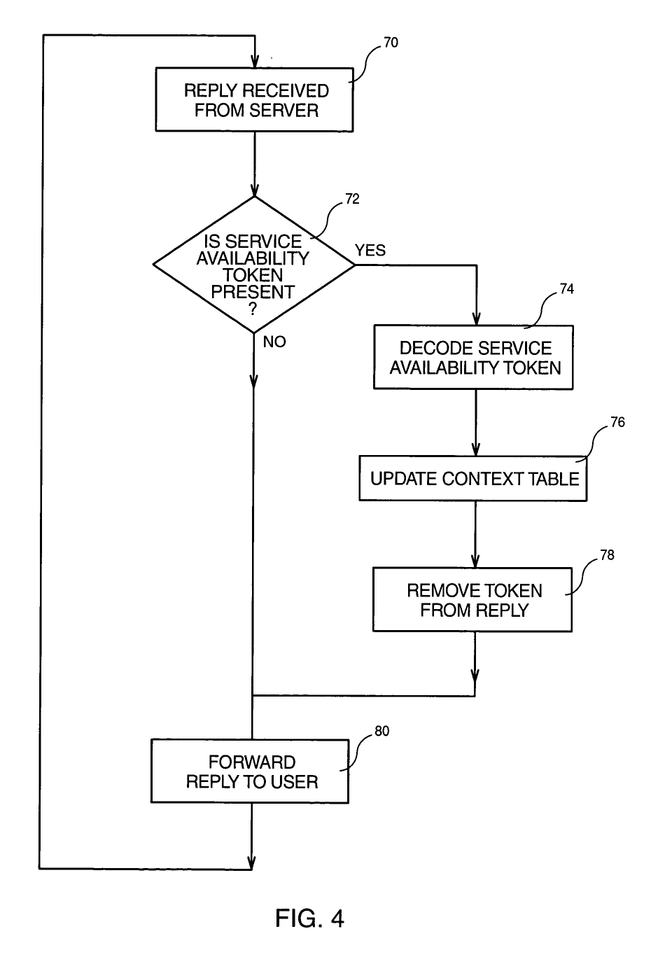

The part of the method relating to the steps implemented in the proxy when receiving the reply from the server to a service availability request is illustrated by the flow chart of FIG. 4. First, the reply is received by the proxy (step 70). The proxy determines whether a service availability token is present in the reply (step 72). If it the case, the service availability token is decoded by the proxy (step 74). Then, the context table is updated by modifying the parameter “Last received” and writing the parameter “Availability” if necessary (step 76). After that, the token is removed from the reply message (step 78). Then, the reply received without a token or when the token has been removed is forwarded to the user (step 80).

The service availability token appended to the reply sent by the content server contains at least a percentage of availability (0-100%) for the whole server furnishing the service and may contain detailed information such as:
A specific URL of a resource served by the server that needs to be monitored:
Maximum number of requests/timeframe (seconds or minutes) allowed for this URL
Redirect URL
Service availability time-window

In a preferred embodiment of the invention this information could be encoded in XML format, thus requiring a Document Type Definition file that describes the tags supported in the Service Availability Profile. For example the DTD description below specifies 4 tags (RES_TYPE, RES_ID, RES_AVAILABILITY, RES_UNIT) for each RESOURCE. A Single Service Availability Profile may contain several resource information.

```
<?xml version=‘1.0’ encoding=“UTF-8”?>
<!ELEMENT RESOURCE
  (RES_TYPE,RES_ID,RES_AVAILABILITY,RES_UNIT)
>
<!ELEMENT RES_AVAILABILITY
  (#PCDATA)
>
<!ELEMENT RES_ID
  (#PCDATA)
>
<!ELEMENT RES_TYPE
  (#PCDATA)
>
<!ELEMENT RES_UNIT
  (#PCDATA)
>
<!ELEMENT SAP
  (RESOURCE+)
>
```

Thus, a reply containing a service availability token would look like:

HTTP/1.1 200 ok
Server: Netscape-Enterprise/4.0
Date: xxx
Content-type : text/html
Service-availability token: “<?xml
version=“1.0”?>< !DOCTYPE SAP SYSTEM sap.dtd $$>
<SAP> <RESOURCE> <RES_TYPE> url </RES_TYPE>
<RES_ID> </start.html> </RES_ID> <RES_AVAILABITY> 3
/RES_AVAILABILITY>
<RES_UNIT> minute </RES_UNIT> </RESOURCE> </SAP>”

It is to be appreciated by those skilled in the art that while the invention has been particularly shown and described with reference to an embodiment thereof, various changes in form and details may be made without departing from the spirit and scope of the invention.

1. Method for ensuring the availability of a service proposed by a service provider in a data transmission system including at least one user workstation connected to the Internet network, a plurality of content servers able to furnish services provided by service providers in response to service requests from said user workstation, and a proxy server interconnected between said Internet network and said content servers for receiving said service requests from said user workstation and transmitting each one to a content server able to provide the requested service;
said method including the following steps when said proxy server receives a service request,
looking in a context table for an entry corresponding to a Uniform Resource Locator (URL) defined in said service request in order to determine the content server able to provide the requested service,
appending a service availability request to said service request before sending said service request from said proxy server to said determined content server,
appending a service availability token to the reply provided by said determined content server before sending said reply from said determined content server to said proxy server,
removing said service availability token from said reply upon reception thereof by said proxy server, and
updating said context table in said proxy server before sending said reply to said user workstation by using information contained in said service availability token.

2. Method according to claim 1, wherein said context table includes several entries corresponding to several URLs associated with a same server name.

3. Method according to claim 2, wherein said context table contains as a parameter for each entry an “availability” of the associated URL which is a percentage of availability or “not available.”

4. Method according to claim 3, wherein said service request is rejected if the parameter “availability” in said context table is defined as not available.

5. Method according to claim 4, wherein said context table includes multiple entries for the same server name, the entry with the parameter “availability” being the highest one selected in the step of looking for an entry.

6. Method according to claim 5, wherein said context table contains several parameters associated with said service availability request being sent which are updated when said service availability request is sent from said proxy server to said content server.

7. Method according to claim 6, further comprising the step of refreshing the entry of said context table by taking into account variables which are a function of parameters included in said context table.

8. Method according to claim 7, wherein the parameter “availability” of said context table is set to “not available” when said number of retries is equal to a predetermined maximum number.

9. Method according to claim 8, wherein said service request is written in HyperText Markup Language (HTML) and said service availability request is contained in a header of said HTTP service request.

10. Method according to claim 9, wherein said service availability token is in Extensible Markup Language (XML) format.

11. Method according to claim 10, wherein said context table is updated when receiving said service availability token from said content server, and the parameter “availability” is changed if necessary.

12. System comprising means adapted for implementing the steps of the method according to claim 1.
